(19) United States
(12) Patent Application Publication
(10) Pub. No.: US 2017/0135322 A1
(43) Pub. Date: May 18, 2017

(54) A BIOCONTROL COMBINATION AND METHOD FOR IMPROVING QUALITY OF SHELLED EGGS

(71) Applicant: NOBACTRA ISRAEL Ltd., Sde Warburg (IL)

(72) Inventor: Giora KRITZMAN, Raanana (IL)

(73) Assignee: NOBACTRA ISRAEL Ltd., Sde Warburg (IL)

(21) Appl. No.: 15/323,900

(22) PCT Filed: Jul. 7, 2015
(86) PCT No.: PCT/IL2015/050702

§ 371 Date: Jan. 4, 2017

(30) Foreign Application Priority Data
Jul. 9, 2014 (IL) 233570

(51) Int. Cl. A01K 45/00; A01N 61/00; A01N 63/00; A01K 43/00

(52) U.S. Cl. CPC A01K 45/007; A01K 43/005; A01N 61/00; A01N 63/00

(57) ABSTRACT

Provided is a biocontrol combination and method for improving quality of a shelled egg, for example, by reducing pathogen contamination. The combination may include at least one first component including particulate matter holding at least one natural oil and at least one second component including a cocktail of antagonistic bacteria. The first component and second component may be combined into a formulation prior to application onto the shelled egg surface. The method may additionally include applying the biocontrol combination onto shelled eggs. Also provided is a package including the biocontrol combination and instructions for use thereof.

### TECHNOLOGICAL FIELD

The present disclosure concerns pathogen biocontrol of shelled eggs.

### BACKGROUND ART

References considered to be relevant as background to the presently disclosed subject matter are listed below:
Inne Gantois et al. “Mechanisms of egg contamination by Salmonella Enteritidis” REMS Microbiol. Rev 33:718-738 (2009)
International patent application publication No. WO08/084485
International patent application publication No. WO10/101679

Acknowledgement of the above references herein is not to be inferred as meaning that these are in any way relevant to the patentability of the presently disclosed subject matter.

### BACKGROUND

In the poultry industry there is an increasing demand for more effective disinfecting techniques so as to increase consumers' health safety.

Good egg hygiene has proven to improve the viability and quality of day old chick and safety of consumption eggs, by reducing the amount of external eggshell contaminations. Bactria and mold that may affect egg quality are abundant in the egg's surrounding environment, and in particular, in the soil on which the eggs lie. Once in contact with the egg's shell, the bacteria and mold may penetrate the egg through its shell and affect various aspects in the quality of the eggs, including, among others, increase embryonic mortality, lead to egg yolk infection, and increase the rate of chick mortality in the first weeks of age etc.

Eggs may be contaminated via two different routes: vertical transmission through the ovary or transovarian or horizontal transmission through the shell or trans-shell. Through vertical transmission, bacteria are introduced from infected reproductive tissues to eggs prior to shell formation. This form of transmission is mostly associated with pathogenic bacteria, namely Salmonella. Horizontal transmission usually occurs from faecal contamination on the egg shell as the eggs are released via the cloaca, where the excretion of faeces also takes place. It also includes contamination through environmental vectors, such as farmers, pets and rodents.

Mechanisms of egg contamination by Salmonella Enteritidis has been reviewed [Inne Gantois et al. REMS Microbiol. Rev 33:718-738 (2009)].

Efforts to minimize horizontal transmission of pathogens and thus increase productivity of eggs include optimizing environmental conditions during egg incubation, anti-bacterial injection into the eggs, treatment with fumigants or other types of disinfectants to reduce the number of microorganisms on the shell surface, improving sanitary conditions etc.

In addition, methods for treatment of the egg's shell were developed. Some include application of antimicrobial agents such as aqueous solutions of oxidizing agents; some other include treatment without antibacterial agents, that involve forming a coating over the egg's shell, that does not penetrate into the interior of the egg.

For example, WO08/084485 describes a composition and method for improving hatching of hatchery eggs comprising: (a) treating the egg shell surface with a coating composition comprising a coating agent, to form a coating on the surface of the egg's shell; and (b) incubating the egg under conditions to cause hatching to occur; wherein the yield of hatching of said hatchery eggs is improved as compared to control eggs not treated as defined in (a).

WO10/101679 describes a method for increasing the productivity of fertilized avian eggs comprising a) treating the egg's outer surface with a liquid coating composition comprising an aqueous solvent, a film-forming coating agent; and one or more surfactants; b) allowing the liquid coating composition to form a coating on the egg, and c) incubating the egg under conditions to cause hatching to occur; wherein the productivity of the avian eggs is increased as compared to control eggs not treated as defined in (a) to (b). The coating is described to facilitate mechanical enforcement of the shell, protection against adverse environmental conditions, prevention of contamination, differentiation of egg parentage and allow for appropriate gas exchange during storage or shipping periods.

### GENERAL DESCRIPTION

The present disclosure provides a biocontrol combination for use in a method of improving quality of a shelled egg, the biocontrol combination comprising at least one first component comprising particulate matter holding at least one natural oil and at least one second component comprising a cocktail of antagonistic bacteria, wherein said first component and second component are combined into a biocontrol formulation prior to application onto the shelled egg surface.

In the context of the present disclosure the improvement of quality of the shelled egg is exhibited at least by one of the following parameters:

(a) disinfecting biological contamination;

(b) improving freshness grade of the shelled eggs as determined with a representative egg from a population of shelled eggs that received said formulation using the Haugh freshness index;

(c) improving hatchability of fertilized eggs; and

(d) elongating shelf life of edible (non-fertilized) eggs.

In accordance with another aspect, the present disclosure provides a method for improving quality of shelled eggs, the method comprises applying onto the shelled egg a biocontrol formulation comprising components of the biocontrol combination disclosed herein, the biocontrol combination comprising at least one first component comprising particulate matter holding at least one natural oil and at least one second component comprising a cocktail of antagonistic bacteria.

In accordance with yet another aspect, the present disclosure provides the use of a biocontrol combination of components comprising (i) at least one first component comprising particulate matter comprising at least one natural oil; (ii) at least one second component comprising a cocktail of antagonistic bacteria, the use being for the preparation of a biocontrol formulation for improving quality of a shelled egg.

In some embodiments, the biocontrol combination is provided in a form of a two membered package where the at least one first component and the at least one second component are separately sealed, the package further comprising instructions for use of the components for improving quality of shelled eggs.

### BRIEF DESCRIPTION OF THE DRAWINGS

In order to better understand the subject matter that is disclosed herein and to exemplify how it may be carried out in practice, embodiments will now be described, by way of non-limiting example only, with reference to the accompanying drawings, in which:

FIGS. 1A-1B are photographic images of eggs with treatment using the biocontrol formulation disclosed herein (FIG. 1A) and without treatment, showing the colonies (marked with arrows) (FIG. 1B).

### DETAILED DESCRIPTION OF EMBODIMENTS

The present disclosure is based on the finding that a water based formulation obtained from a cocktail of soil borne antagonistic bacteria (first component) and natural oils (second component) such as oregano oil and sesame oil were effective in reducing, if not eliminating at all, pathogen load on, at least, the surface of poultry eggs. The formulation was prepared by mixing the two active components, namely, the cocktail of bacteria and the natural oils (on particulate matter) prior to use and the effect was even improved when to the resulting mixture, diammonium phosphate, a commonly used inorganic salt, was added at low amounts.

The application of the biocontrol formulation can exhibit any one of reducing contamination levels (either or both bacterial and fungal) as well as, or alternatively, improve hatchability of fertilized eggs and/or elongate the shelf life of edible (non-fertilized) eggs.

Based on the findings disclosed herein, the inventor has concluded that application of the biocontrol formulation provided by the at least first and second components as defined herein, provided an overall unexpected improvement in the quality of the shelled egg (irrespective of whether it is for hatching or for eating).

Thus, in accordance with a first of its aspects, the present invention provides a biocontrol combination (which can be provided in the form of a kit or a package) for use in a method of improving quality of shelled eggs, the combination comprising at least one first component comprising particulate matter holding at least one natural oil and at least one second component comprising a cocktail of antagonistic bacteria, wherein the first component and second component are combined into a biocontrol formulation prior to use on the surface of the egg's shell.

The biocontrol combination can be provided in a form of a two component package that also includes instructions for use of the two components therein, said instructions comprise mixing the first component and the second component to form a formulation and applying the formulation onto said eggs.

In accordance with a further aspect, the present invention provides a method of improving quality of shelled eggs the method comprises applying onto the egg's shell biocontrol formulation comprising components of the biocontrol combination comprising a first component comprising particulate matter holding at least one natural oil and a second component comprising a cocktail of antagonistic bacteria disclosed herein.

Further provided by a further aspect of the present disclosure is the use of a combination of components comprising the herein defined at least one first component and at least one second component for the preparation of a biocontrol formulation, preferably aqueous based formulation, for improving quality of shelled eggs.

Yet further, in accordance with fourth further aspect, there is provided by the present disclosure a method of preparing a formulation for disinfecting a shelled egg surface.

Finally, there is provided herein a package for improving quality of shelled eggs, the package comprises at least one first component comprising particulate matter holding at least one natural oil, at least one second component comprising a cocktail of antagonistic bacteria; and instructions for use of said at least one first component and said at least one second component for preparing a bioconrol formulation for improving quality of shelled eggs, the instructions comprising at least mixing said at least one first component with said at least one second component.

The following description applies to each and every aspect of the present disclosure.

In the context of the present disclosure, when referring to “improvement of quality” of shelled eggs (i.e. eggs having an outer covering comprising calcium carbonate), it is to be understood as meaning improvement of any parameter known to those in the art of poultry cultivation, including, without being limited thereto, reduction in pathogenic (e.g. fungi, bacterial) contamination on the eggs shell surface, reduction in pathogenic contamination in the eggs (typically determined based on a sample egg(s) taken from a population of eggs being treated in accordance with the present disclosure); elongation of shelf life (as compared to that of non-treated egg), increase in freshness determined according to Haugh index, increasing level of hatching, all being determined by procedures known in the art.

Further, in the context of the present disclosure “increasing hatchability” denotes a statistical increase in the number of hatched eggs and/or increase in the wellness of the hatched chicks as well as any other parameter known in the art. The increase is determined based on a comparison with a group of non-treated eggs.

Yet further, in the context of the present disclosure “elongating shelf life” denotes an elongation in at least a day (in average) of the freshness of non-fertilized eggs as compared to that of non-treated eggs stored under the same conditions.

The formulation is prepared by mixing, preferably also with water, at least the two components of the biocontrol combination (the said at least one first component and at least one second component). The result of the mixing/combining the two components provides a biocontrol formulation, the content of which being further discussed below.

In some embodiments, the biocontrol formulation is applied shortly after its preparation, namely, it is a freshly prepared formulation and the mixing is thus regarded as shortly prior to application. When referring to a freshly prepared formulation it is to be understood as one being applied onto the eggshell not more than 48 hours, at times, not more than 24 hours, and preferably not more than 12 hours, or even 6 hours after mixing at least the first component and second component of the biocontrol combination, i.e. the biocontrol formulation. In some embodiments, the biocontrol combination is used within about 12 hour time window after mixing the two components thereof.

The two different types of components (namely, the at least one first component and at least one second component), the contents of which are discussed below, are diluted with water so as to form the biocontrol formulation that is suitable for application onto the eggs.

The biocontrol formulation can be applicable for disinfecting any type of shelled egg and is effective in at least reducing the pathogen load on the surface of the shell. Thus, in the context of the present disclosure, when referring to an egg it is to be understood as meaning any egg that has a shell coating over the thin membranes holding the albumen. The shell can be a hard shell or soft shell. In some embodiments, the shell is hard shell such as the shell of avian eggs (birds). In some other embodiments, the shell is a soft shell, such as of marine turtles.

In some embodiments the egg is an avian (bird) egg. This includes any type of bird, such as pet birds, birds laying edible eggs and wild birds.

When referring to bird laying edible eggs it is to be understood to encompass any type of bird that lays eggs i.e., when non-fertilized, are consumed by mammals, including, without being limited thereto, chicken that are the most common providers of edible eggs, as well as other edible eggs such as duck, pheasant, quail, goose, turkey, ostrich, pigeon and emu.

The eggs to be treated for improving their quality in accordance with the present disclosure can be edible (i.e. non-fertilized) or fertilized eggs. As will be shown in the following examples, the treatment and specifically disinfection does not reduce or damage the quality of hatching and as such is considered inert to the quality of reproduction.

The biocontrol formulation obtained in accordance with the present disclosure can be applied to free-range eggs as well as to eggs laid within a coop, poultry enclosure or incubator. Under either growing environment, the eggshell (soft or hard) is known to potentially carry a variety of pathogens and in particular, pathogens that can infect the developing chick or that may cause a disease in the mammal handling or consuming the egg (fertilized or non-fertilized egg).

When referring to a pathogen it is to be understood as encompassing particularly a disease causing biological agent. This may include bacteria, fungi and protozoa from any source, including, without being limited thereto, soil borne pathogen, air carried pathogen, manure pathogen, and water carried pathogen.

In some embodiments, the pathogen is bacteria or fungi.

When the pathogen is fungi, a non-limiting list of disease causing fungi includes any one selected from the group consisting of Aspergillus flavus, Aspergillus niger, Aspergillus fumigates, Penecillium oxalicum, Penecillium rugulosum, Fusarium ograminarium, Fusarium spp., Mucor spp., Rhizopus spp., Cladosprium spp., Penicillium spp., Monilia spp.

When the pathogen is bacteria, a non-limiting list of disease causing bacteria includes any one selected from the group consisting E. Coli, Pseudomonas (e.g. Pseudomonas aeruginosa), Staphylococus (e.g. Staphylococcus aureus), Enterococcus Spp., Serratia Marcescenes, Proteus vulgaris, Salmonella sp.

The combination is effective in control of any potentially existing pathogen on at least the surface of the shell. When referring to disinfection or control (or biocontrol) of the egg's shell it is to be understood as any statistically significant reduction of the risk of developing a disease as a result of existence of one or more pathogens on the surface of the egg as determined by conventional statistical tests. The disinfection may include reduction of the level/concentration/amount of one or more pathogens on at least the surface of the egg's shell, as well as complete elimination of one or more pathogens on the said surface. In some embodiments, the disinfection comprises at least a two log reduction of the pathogens on the outer surface of the eggshell.

The biocontrol formulation can be applied by any technique available in the art. This includes, without being limited thereto, dipping the eggs in a formulation comprising the combined components of the biocontrol combination; spraying the formulation onto the egg's shell; rolling the egg over a substrate absorbed with said formulation; brushing the egg's shell with the solution, introducing or maintaining the eggs in a mist formed from such formulation.

In some preferred embodiments, the biocontrol formulation is applied by spraying the eggs with a solution comprising the combined biocontrol components.

The application provides a coating over the eggshell. The coating may be a continuous (full) coating of the eggshell or non-continuous, i.e. where the shell's surface has areas with no coating and other areas with coating by the natural oil and/or at least one antagonistic bacterium or the coating is a net-shaped or web-shaped coating with the combination constituting the web's strings.

In some embodiments the coating, continuous or non-continuous, is inert with respect to gas exchange from within the egg or into the egg. In other words, the coating formed by the applied combination does not interfere with oxygen or other gases exchange between the egg's interior (inner egg) and exterior surface.

In some embodiments, the biocontrol formulation is maintained outside the inner membrane, and does not penetrate beyond the inner membrane of the egg, namely, does not come in contact with the inner egg and the albumen.

The biocontrol combination can be used once or more than once during the period from day of laying until day of hatching or removal from the incubator or other type of enclosure (e.g. when the eggs are edible eggs) for marketing or other purposes.

While a single application of the biocontrol formulation may suffice for achieving the desired disinfecting effect, in some embodiments the formulation is applied at least twice, at times trice or even more, until the eggs are either hatched or are moved from the enclosure/incubator.

In some other embodiments, the biocontrol combination is used by a single application of the thus formed formulation once onto the eggs and then maintaining the eggs in a mist environment continuously or periodically including the biocontrol formulation.

Turning now to the contents of the first and second components of the biocontrol combination:

The content (composition) of the first component and second component of the biocontrol combination is described herein below and in further detail in International patent application No. PCT/IL2014/050348 bearing the publication number WO2014/170894 the content of which is incorporated herein by reference it its entirety.

As noted above, prior to use the first component and the second component are mixed together. Upon this mixing a stable emulsion is obtained, which may then be diluted with water and is suitable for application onto the eggs to be disinfected. In some embodiments, the mixing comprises first suspending in water the at least one first component to form an emulsion and then mixing the emulsion with the at least one second component. Additional substances, such as the inorganic salt can be added at any stage of preparation.

The first component comprises particulate matter holding at least one natural oil.

In the context of the present disclosure, the term “particulate matter” is used to denote a substance in the form of plurality of particle. The particles may be in any particulate form, including, without limited thereto, from finely rounded beads to amorphous structures. The particulate matter includes any form of a powder.

In some embodiments, the particulate matter comprise silica dioxide (SiO₂, in short referred to herein as silica). The silica may be naturally occurring silica particles such as bentonite clay beads, as well as synthetic silica beads.

In some embodiments, the particulate matter comprises synthetic silica particles. There are a variety of synthetic silica particles that may be used in the context of the present disclosure. For example, the particulate matter may comprise precipitated synthetic amorphous silica beads, such as the commercially available products Tixosil, Sipernat 50S (SiO₂, 20 μm) and Aerosil 200.

In some other embodiments, the particulate matter comprises synthetic or nature derived beads with the capacity to absorb the natural oils. Such beads may include, without being limited thereto Latex beads; calcium carbonate sorbent particle; cellulose beads; polystyrene adsorbents beads e.g. Amberlite® XAD®-2 which is a hydrophobic crosslinked polystyrene copolymer absorbent resin; charcoal; Sepharose™ beads; emulsan-alginate beads; chitosan beads; sodium alginate; styrene-maleic acid copolymer beads and styrene-divinylbenzene beads; cellulose paper beads.

To allow good distribution of the final formulation and in accordance with some embodiments the particulate matter (particles) has a size distribution in the range of 10-25 μm.

The particulate matter may also be characterized, without being limited thereto, by one or more of a surface area, in some embodiments, in the range of 400-500 m² N₂/g and oil capacity in the range of 300-350 DBP/100 gram particulate.

The at least one first component comprises the particulate matter that holds one or a combination of natural oils. In the context of the present disclosure it is to be understood that “natural oil” encompasses any organic oil obtained from nature.

The natural oil is preferably oil derived from a plant. In some embodiments, the natural oils are known as essential oils.

The essential oils are preferably those known to exhibit antimicrobial (e.g. antibacterial, antifungal, antinematodal) properties. When referring to anti-microbial properties it is to be understood as being effective against any microbial pathogen, as further discussed below. Without being limited thereto, essential oils to be used in accordance with the present disclosure, may be those derived from the plants Origanum vulgare and Origanum spp., (e.g. Oregano), Mentha spp. (mint), Thymus spp. (Thyme), Myrtus spp., Ocimun spp. (e.g. Ocimun basilicum, also known as Basil), Lavandula spp. (e.g. Lavender), Micromeria spp., Coriandum spp. (e.g. Coriander/Parsley), Aloysia spp., Melissa spp., Salvia spp., Petoselinum spp., Rosmarinus spp. (e.g. Rosemary), Prunella spp., Cuminum spp (e.g. Cumin).

In some other embodiments, the natural oils are plant derived oils that is used as carbon source, e.g. as food/nutrient for the antagonistic microorganisms. These are referred to herein the term “carbon-base oil” or “carbon-rich nutrient oil”. In some embodiments, the carbon-base oils are vegetable oils. Without being limited thereto, the carbon-base oil is selected from the group consisting of Sesame oil, Olive oil, Peanut oil, Cottonseed oil, Soybean oil, Palm oil, sunflower oil, safflower oil, canola oil, castor oil, coconut oil, groundnut oil.

In the context of the present disclosure, when referring to “natural oil”, it is to be understood as referring to a single type of oil and to a combination of oils. In some embodiments, the natural oil encompasses a combination of at least one essential oil and at least one carbon-base oil, both being of natural source.

In some embodiments, the natural oil comprises at least Oregano oil in combination with at least one carbon-base oil. The Oregano oil is combined, at times, with at least Sesame oil.

The amount of the natural oil within the first component (e.g. held by the particulate matter) may vary, depending on the type(s) of the natural oil used, the amount at loading, the type of particulate matter, the conditions of loading the natural oil onto the particulate matter, the surfactants or solvents used for loading etc.

When referring to loading of the oil onto the particulate matter, it is to be understood as meaning any form of association between the oil and the particulate matter (e.g. silica particles). Without being limited thereto, the oil is held by the particulate matter by absorption onto and/or into the particles. The association between the particles and the oil is reversible, namely, under suitable conditions, such as when brought into contact with water, the oil is easily released from the particles to form an emulsion.

In some embodiments, the particulate matter holds between 20% to 50% w/w natural oil out of the total weight of the particulate matter (after loading). This is determined by conventional techniques such as HPLC or GC chromatography, as also exemplified below. In some other embodiments, the particulate matter holds about 30% w/w natural oil (“about” encompasses a range of between 25-35%, at times between 28% to 32% or around 30%).

In some embodiments, the natural oil comprises either only the essential oil(s) or a combination of at least one essential oil and at least one carbon-base (carbon rich) oil. As such, when referring to natural oils it is to be understood as encompassing essential oil(s) as well as carbon-base oil(s). The ratio between the at least one essential oil and at least one carbon-base oil is in the range of 60:40 and 100:0, at times the range is about 80:20.

When a combination of oils is used it is to be understood that they may be absorbed onto the particulate matter together, i.e. the same particulate matter holds more than one type of oil. In some embodiments, for ease of handling, each oil type is held separately on particulate matter such that different types of particulate matter are formed, each being characterized by the type of oil it is holding.

Thus, when referring to particular matter providing Oregano and Sesame at a ratio of 80:20 it is to be understood as a mixture of two populations of particulate matter, 80% carrying Oregano oil and 20% of a type carrying Sesame oil or a single population of particles, each particle being absorbed with the two oils at the defined or desired ratio (i.e. the oils are a priori mixed and then brought into contact with the absorbing carrier/particle). Irrespective of the oil type, the particulate matter between 20% to 50% w/w of its total weight it provided by the oil loaded thereon.

The particulate matter may also comprise at least one surfactant. As appreciated, a surfactant is a compound that lowers the surface tension of a liquid and as such, the interfacial tension between two liquids to allow the formation of, e.g. an emulsion. The surfactant may be of any kind known in the art as safe for use (e.g. non-toxic to plants or animals), including ionic surfactants, anionic surfactants, cationic surfactants as well as zwitterionic (or non-ionic) surfactants.

In some embodiments, the surfactant is of a type acceptable in organic agriculture. A non-limiting list of possible surfactants to be used in accordance with the present disclosure includes Polyethylene glycol, sorbitan trioleates (Tween, e.g. Tween 85, Tween 65, Tween R85), sorbitan fatty acid esters (e.g. Span 40), Egg Lecithin, Zohar LQ-215 (Potassium fatty acids) and Zohar PT-50 (Potassium fatty acids), Carvacrol.

In some other embodiments, the surfactant comprises a salt of a fatty acid. The salt may comprise an alkaline such as potassium, calcium, sodium salts, as well as an ammonium salt.

In some embodiments, the salt of a fatty acid comprises potassium salts of fatty acids (also known as soap salts), which are at times used as insecticides, herbicides, fungicides, and/or algaecides. In some embodiments, potassium salts of fatty acids may be obtained by adding potassium hydroxide to natural fatty acids such as those found in animal fats and in plant oils. Fatty acids may be extracted from olives, cotton seeds, soya beans, peanuts, sun flowers, coconuts palm, rapeseed, sesame oil, amaranth, corn, jatropha.

The fatty acid forming the surfactant may also be a synthetic fatty acid as well as a semi-synthetic (e.g. a natural fatty acid that underwent a modification).

In accordance with some embodiments, the at least one surfactant is one being recognized or is labeled as having an insecticide and/or fungicide activity. Without being limited thereto, pesticidal and/or fungicidal surfactants may include the commercial products Zohar PT-50 and Zohar LQ-215, both produced by Zohar Dalia, Israel.

In one particular embodiment, the surfactant is selected from Zohar PT-50 and Zohar LQ-215.

The compositions of these surfactants are available from Zohar Dalia. For instance, Zohar PT-50 is known to have the composition as shown in Table 1 below:

TABLE 1
Surfactants compositions
Vegetable oils

| | | | Polyunsaturated fatty acids | | | | |
|---|---|---|---|---|---|---|---|
| | | Mono- | | linolenic | Linoleic | Oleic | |
| | Saturated | unsaturated | Total | acids | acid | acid | Smoke |
| Type | fatty acids | fatty acids | poly | (ω-3) | (ω-6) | (ω-9) | point |

Not hydrogenated

| | | | | | | | |
|---|---|---|---|---|---|---|---|
| Canola | 7.365 | 63.276 | 28.14 | 9-11 | 19-21 | — | 204° C. |
| (rapeseed) | | | | | | | |
| Coconut | 91.00 | 6.000 | 3.000 | — | 2 | 6 | 177° C. |
| Corn | 12.948 | 27.576 | 54.67 | 1 | 58 | 28 | 232° C. |
| Cottonseed | 25.900 | 17.800 | 51.90 | 1 | 54 | 19 | 216° C. |
| Flaxseed/ | 6-9 | 10-22 | 68-89 | 56-71 | 12-18 | 10-22 | 107° C. |
| Linseed | | | | | | | |
| (European) | | | | | | | |
| Olive | 14.00 | 72.00 | 14.00 | <1.5 | 9-20 | — | 193° C. |
| Palm | 49.300 | 37.000 | 9.300 | — | 10 | 40 | 235° C. |
| Peanut | 16.900 | 46.200 | 32.00 | — | 32 | 48 | 225° C. |
| Safflower | 8.00 | 15.00 | 75.00 | — | — | — | 210° C. |
| (>70% | | | | | | | |
| linoleic) | | | | | | | |
| Safflower | 7.541 | 75.221 | 12.82 | — | — | — | 210° C. |
| (high oleic) | | | | | | | |
| Soybean | 15.650 | 22.783 | 57.74 | 7 | 50 | 24 | 238° C. |
| Sunflower | 10.100 | 45.400 | 40.10 | 0.200 | 39.800 | 45.300 | 227° C. |
| (<60% | | | | | | | |
| linoleic) | | | | | | | |
| Sunflower | 9.859 | 83.689 | 3.798 | — | — | — | 227° C. |
| (>70% | | | | | | | |
| oleic) | | | | | | | |

Fully hydrogenated

| | | | | | |
|---|---|---|---|---|---|
| Cottonseed | 93.600 | 1.529 | .587 | | .287 |
| (hydrogenated) | | | | | |
| Palm | 47.500 | 40.600 | 7.50 | | |
| (hydrogenated) | | | | | |
| Soybean | 21.100 | 73.700 | .400 | .096 | |
| (hydrogenated) | | | | | |

Values as percent (%) by weight of total fat.

The amount of the surfactant in the first component may vary. However, in some embodiments, the particulate matter comprises between 5% to 10% w/w of the surfactant or combination of surfactants.

The first component, prior to mixing with the second component, comprises the particulate matter is in an essentially dry form. When referring to “essential dry” it is to be understood that the first component may contain low amounts of water, in some embodiments not more than 10% (w/w). In some other or additional embodiments, the water content in the first component is within the range of 1% to 7% (w/w). In yet some other embodiments, the “essential dry” is to be understood as encompassing no water being detected by conventional methods (i.e. no detectable amount of water).

The first component may also contain some trace amounts of an organic solvent. As will be further discussed below, a solvent may be required for the preparation of the particulate matter and some residual amounts may remain, as long as the solvent is not toxic. In some embodiments, the first component is either solvent free (i.e. contains no detectable amounts of an organic solvent) or comprises trace amount, i.e. not more than 5%, 4%, 3% or even 2% w/w organic solvent. The solvent is typically an organic volatile polar solvent, such as, without being limited thereto, a solvent selected from the group consisting of acetone, isopropyl alcohol (isopropanol, IPA), acetonitrile, acetone, ethanol and methanol. In some embodiments, trace amounts of alcohol are detected in the first component.

The particulate matter of the first component is unique in its capability of forming a stable emulsion, once the particulate matter is brought into contact with water or with the second component. This is achieved, inter alia, due to the presence of a surfactant in the first component. The surfactant is added to the particles with the oil, before bringing the components into dryness.

When referring to a stable emulsion it is to be understood as referring to dispersion of oil (the dispersed phase) in water (the dispersion medium) for a period of at least lhour, at times, at least 2, 3, 4, 5, 10, 12 or even 24 hours following the formation of the emulsion. In other words, the stability is determined by the lack of separation into an oil phase and a water phase. The lack of separation may be determined by any means known in the art, including visible inspection.

To form the emulsion, the particulate matter is mixed with water or with the water contained in the second component. The amount of water depends on the amount of particulate matter. In some embodiments, for each gram of particulate matter (30% of which is oil) water is added to provide a one liter emulsion. As such, in a 1 liter emulsion, 0.1 gr particulate matter provides an oil concentration of 0.03% v/v). In some embodiments, the percentage of oil in the final emulsion is in the range of 0.03% and 2% v/v.

In some embodiments, the mixing of the particulate matter with water provides an emulsion with a droplet size in the range of between 1 to 20 μm and in some embodiments in the range between 3 to 10 μm.

In some embodiments, the emulsion is an anti-microbial emulsion.

Reverting to the second component, it posses an antagonistic activity. In the context of the present disclosure, when referring to antagonists of a microbial pathogen (antagonistic bacteria) or a pathogen antagonist, it is to be understood as a biological entity that inhibits the plant pathogen (a plant pathogen may also be referred to as a phytopathogen). Inhibiting, in the context of the present disclosure is to be understood as reducing growth of the pathogen by at least 50%, at least 70%, at least 90% or even by essentially eliminating the pathogen. The plant pathogen, in the context of the present invention may be any prokaryotic or eukaryotic organism, including, without being limited thereto bacteria, a fungi, protozoa, nematodes, or any other disease causing parasite. As such, the microbial activity of the at least one antagonist, may any one of antibacterial, antifungal, antiprotoxoal, antinematodal etc.

The second component comprises at least two antagonistic bacteria and in some preferred embodiments, the second component comprises a cocktail of several antagonists. The cocktail is to be understood as a combination of two or more, at times, 3, 4, 5, 6, 7, 8, 9, 10, 11, 12, 13, 14 or 15, antagonists combined together in the same or different concentrations.

In some embodiments, the at least one antagonist is of a type capable of growing on sesame oil as a sole carbon source. Such antagonists may be easily identified by conducting conventional cultivation assay using sesame as the sole carbon source and identifying those cultivars that survived the experimental growing period. Specifically, the antagonistic bacteria that may be used in accordance with the present disclosure is one that may be distinguished from other bacteria having no antagonistic activity towards at least Clavibacter michiganensis subsp. Michiganensis (CBM), the cause of tomato bacterial canker; or is one that is capable of growing on carbon base oil, such as sesame oil. In one embodiment, the carbon base oil on which all antagonistic bacteria grow (while non-antagonistic bacteria tested do not) is sesame oil.

In some embodiments, the antagonist may be referred to as a bacteriostate, i.e., that slows down growth of organisms, and in some other embodiments, the antagonist may be referred to as a bactriocide, namely, that kills the organism.

In some embodiments, the at least one antagonist of a microbial pathogen is a soil born antagonist. In this context it is to be understood that the at least one antagonist may be obtained and isolated from the roots, soil and/or rhizophere of a plant that was shown to be tolerant (e.g. partially resistant) or resistant to the microbial pathogen.

In some other embodiments, the antagonist of a microbial pathogen is a plant derived antagonist, e.g. isolated from a plant part, such as the leaves, the stem, the flower, the vascular system.

The antagonist of a microbial pathogen may also be present and thus derived from the soil (i.e. soil born) and from a plant part (e.g. the vascular system).

As noted above, the at least one second component may include more than two antagonists. In some embodiments, the second component includes a combination of several antagonists in the same gel, i.e. a cocktail. However, in some other embodiments, when combinations of antagonists are to be used, they can each be carried by a separate gel and mixed only prior to use. When using a combination or two or more antagonistic bacteria, the combination is referred to herein as an antagonistic cocktail.

When a combination of antagonists is used, the antagonists can be provided/applied to the plant in the same amounts (CFU/ml) or in different amounts.

In accordance with some embodiments, the amount of an antagonists in the second component (either as a single antagonist or as a cocktail of antagonists) can be in the range between 500 to 5,000 CFU/ml/. The ratio between the antagonists, when used as a cocktail may vary, depending on the type of pathogen to be treated and can be a priori determined by conventional laboratory methods, e.g. best bacteriostatic/bactriocidal effect in a cultivation dish.

In some embodiments, the preferred antagonists are selected from the group consisting of Pseudomonas species (Accession No. CBS133252), Pseudomonas alcaliphila (Accession No. CBS133254), Bacillus subtilis (Accession No. CBS133255), Pseudomonas cedrina (Accession No. CBS133256), Pseudomonas species (Accession No. CBS133257), Pseudomonas species (Accession No. CBS133258), Pseudomonas species (Accession No. CBS134568), Pseudomonas spanius (Accession No. CBS133259), Pseudomonas mediterranea (Accession No. CBS134566), Pseudomonas chlororahis (Accession No. CBS134567).

Other antagonists that may be used in combination with at least one antagonist listed above, are provided in Table 4 of the Report by the International Organization for Biological and Integrated Control of Noxious Animals and Plants [Edited by Philippe C. Nicot 2011], the content of which is incorporated herein by reference.

In addition, antagonists to be combined with at least one preferred antagonist listed above, may be found in various literatures, such as, without being limited thereto, the following, which are incorporated herein by reference:

| | The | | |
|---|---|---|---|
| | infected | | |
| The Pathogen | plant | The Antagonists | Source of information |
| Ralstonia | Tomato, | Bacillus megaterium, | Journal of Plant Pathology |
| Solanacearum | Pepper | Enterobacter cloacae, | 92(2): 395-406 (2010) |
| | | Pichia guillermondii and | |
| | | Candida ethanolica | |
| E. carotovora | | E-65 as a Bacillus sp. and | The Scientific World |
| subsp. carotovora | | E-45 as a Lactobacillus sp. | Journal (2012), Article |
| P-138 | | | ID 723293. |
| Leptosphaeria | canola | Pseudomonas chlororaphis | Biocontrol Science and |
| maculans | | and P. aurantiaca | Technology 16(5/6): 567582 |
| | | | (2006) |
| Ralstonia | Fungi in | Pseudomonas fluorescens | J. ISSAAS Vol. 18(1): 185-192 |
| solanacearum | peanut | RH4003 and Bacillus | (2012) |
| (Pseudomonas | | subtilis AB89 | |
| solanacearum) | | | |
| Ralstonia | Wilt disease | Pseudomonas | http://www.apsnet.org/publications/PlantDisease/BackIssues/ |
| solanacearum | of potato | solanacearum isolates: | Documents/1983Articles/PlantDisease67n05_499.pdf |
| | | B82; w163; wp95 and P. fluorescens | |
| Rhizoctonia solani | potato | commercial products of | Crop Protection |
| | | Bacillus subtilis (Kodiak) | 24(11): 939-950, (2005) |
| | | Actinomycetes | Phytoprotection 82: 85-102 |
| | | | (2001) |
| Xanthomonas | Bacterial | Streptomyces spp | American Journal of |
| oryzae pv. oryzae | Leaf Blight | | Agricultural and Biological |
| | Disease in | | Sciences 7(2): 217-223 |
| | Rice | | (2012) |
| Xanthomonas | | Isolates from soil and | Rice Indstry, culture, and |
| oryzae pv. oryzae | | water | environment 549-553 |
| Streptomyces spp | Potato scab | | Phytopathology 85: 261-268 |
| | | | (1995); |
| | | | Can J Microbiol. |
| | | | 47(4): 332-40 (2001) |
| Sclerotinia | Soybeans | Bacillus amyloliquefaciens | MSU AgBioResearch 2011 |
| sclerotiorum, | Potato scab | (BAC03) | Annual Report, (2012) |
| Streptomyces sp. | Vegetable | | URL: |
| and Phytophthora | crops | | http://research.msu.edu/stories/getting-root-soil-borne-diseases |
| capsici | | | |
| Rhizoctonia solani | Black Scurf | | Egypt. J. Phytopathol., |
| and | Dry rot of | | 36(1-2): 45-56 (2008) |
| Fusarium | Potato | | |
| sambucinum, | | | |
| Rhizoctonia solani | Lettuce | Endophytic strains, | FEMS Microbiol Ecol |
| | | Serratia plymuthica 3Re4- | 64: 106-116 (2008) |
| | | 18 and Pseudomonas | |
| | | trivialis | |
| | | 3Re2-7, rhizobacterium | |
| | | Pseudomonas fluorescens | |
| | | L13-6-12 | |
| Rhizoctonia solani | Potato | Pseudomonas fluorescens | Acta biol. Colomb. 12(1) |
| | | | (2007) |
| Xanthomonas | Tomato | Rahnella aquatilis | Microbiological Research, |
| campestris pv. | | | 160(4): 343-352 (2005) |
| vesicatoria | | | |
| Erwinia | | Pseudomonas fluorescens | Plant Disease 93(4): 386 |
| amylovora (Fire | | A506, Pantoea | URL: |
| Blight) | | agglomerans C9-1, and | http://apsjournals.apsnet.org/doi/pdf/10.1094/PDIS-93-4-0386 |
| | | Pantoea | |
| Erwinia | | Erwinia herbicola | ISHS Acta Horticulturae |
| amylovora (Fire | | | 117: II Symposium on |
| Blight) | | | Fireblight URL: |
| | | | http://www.actahort.org/books/117/117_21.htm |
| Clavibacter | | Bacillus subtilis; | BioControl 49: 305-313, |
| michiganensis | | Rhodosporidium | 2004 |
| subsp. | | diobovatum | |
| michiganensis | | | |

As noted above, in some embodiments, the antagonist is of a type that is capable of growing on sesame oil as a sole carbon source.

To prepare the bioconrol formulation (in the form of an emulsion), water is used (in addition to the water from the gel). When water is added, the total amount of water will depend on the amount of the first component. In some embodiments, for each gram of first component (e.g. 30% of which are oil) water is added to provide one liter emulsion of the first component. As such, in 1 liter emulsion, 0.1 gr particulate matter provides an oil concentration of 0.03% v/v.

In some embodiments, the percentage of oil in the final emulsion is in the range of 0.03% and 2% v/v.

According to the above, a final formulation may be provided from 20 grams of a powder of the first component (30% of which is the oil), and 120 ml of an antagonist gel of the second component and mixing the first component and the second component with water to form 20 liter emulsion containing 0.3% v/v of oil.

Similarly, a biocontrol formulation may be provided from 50 grams or 100 grams of a powder of the first component, and 120 ml of an antagonist gel of the second component and mixing the first component and the second component with water to form a 50 or 100 liter emulsion.

In some embodiments the first and second components are also combined with at least one inorganic salt. As shown in the non-limiting examples, the addition of an inorganic salt provided improvement of the disinfecting effect as it at least increased the spectrum of activity and/or efficiency of the biocontrol formulation against fungi growth.

There are a variety of inorganic salts that may be used in accordance with the present disclosure. Without being limited thereto, the inorganic salt may be one or more salts selected from the group consisting of ammonium nitrate, ammonium sulfate, ammonium trisulfate, calcium ammonium nitrate, calcium nitrate, diammonium phosphate, monocalcium phosphate, potassium chloride, potassium nitrate and potassium sulfate.

In one embodiment, the inorganic salt is diammonium phosphate (DAP).

In some embodiments, the inorganic salt is in an amount of between 1% to 3% w/w with respect to the first component, at times, between about 1.5% and about 2.5% or about 2%.

The inorganic salt may be added as a third component to the final formulation or may be included in the first component. As such, and in accordance with some embodiments, the first component comprises the at least one organic salt. In some embodiments, the inorganic salt is carried by the particulate matter.

### DESCRIPTION OF SOME NON-LIMITING EXAMPLES

### Biocontrol Formulation

The formulation for biocontrol of the eggs was prepared by mixing two components, dry particulate matter and an antagonistic bacterial cocktail.

### Preparation of Essential Oil Powder

### Materials

For preparing the oil powder, the following materials were used:

### Natural Oils:

Oregano oil 100% (essential oil) and Sesame oil 100% (carbon-base oil), both purchased from Makes Scents Natural SPA line, Lancaster Pa., USA.

Surfactants: Carvacrol purchased from Sigma-Aldrich.
Silica beads: Sipernat 50S (SiO₂, 20 μm) purchased from Evonik Industries AG.

### Solvent: Isopropanol (IPA), Gadot.

### Methods

For laboratory scale production the powders containing the natural oils, surfactants and the silica beads were prepared using common lab glassware set up including laboratory bottles of 20-50 ml sizes, spatulas, magnetic stirrers and heating plates. Generally, the natural oil was weight and each was separately mixed with the selected surfactant in a 20 ml vial, to which the solvent was added. The mixtures of each oil were mixed and heated to a temperature of about 40° C. until homogeneous solutions were obtained. To the homogenous solutions the silica beads were added until the liquid was absorbed by the beads. The bottles were left in the fuming hood overnight until all solvent has evaporated.

Loading of each of the oil in the final dry powders was 30-42%. The dry powders contained 2%-7% water.

Alternative formulations for the oil powder are described in detail in International patent application No. PCT/IL2014/050348 bearing the publication number WO2014/______ the content of which is incorporated herein by reference it its entirety.

### Preparation of Antagonistic Cocktail

### Materials

The antagonistic cocktail comprises, as the active principle, a mixture of soil borne bacteria. The isolation, identification and media condition for production are described in detail in International patent application No. PCT/IL2014/050348 bearing the publication number WO2014/______ the content of which is incorporated herein by reference it its entirety.

Table 1 provides the list of species deposited at the CBS-KNAW institute on Nov. 19, 2012 and used in the final combination/cocktail. The species were stored at −80° C. in a glycerol solution (15%).

TABLE 1
Deposited antagonists

| Antagonist | Accession No. | Name |
|---|---|---|
| Pseudomonas species | CBS133252 | BN12-27A |
| Pseudomonas alcaliphila | CBS133254 | BN12-28 |
| Bacillus subtilis | CBS133255 | BN12-29 |
| Pseudomonas cedrina | CBS133256 | BN12-30 |
| Pseudomonas species | CBS133257 | BN-12-31 |
| Pseudomonas species | CBS133258 | BN12-32 |
| Pseudomonas spanius | CBS133259 | BN12-33 |
| Pseudomonas mediterranea AN1 | CBS134566 | BN13-01 |
| Pseudomonas chlororahis AN10 | CBS134567 | BN13-02 |
| Pseudomonas species AN21 | CBS134568 | BN13-03 |

### Methods

### Preparing Antagonistic Microbial Gel

The isolated antagonists listed in Table 1 were separately transferred to Erlenmeyer flask containing the medium used for multiplication (peptone (10 gr/litre), yeast extract (20 gr/litre), glycerol (10 gr/litre), MgSO₄ (0.1 gr/litre), CaCO₃ (2 gr/litre) supplemented with 0.15% granulated Agar (Difco) and each antagonist at a concentration of between 10⁷ to 10⁸ CFU/ml and shaked for 72 h at 28° C. The resulting gel like cocktail was then kept in gel form, at room temperature until use. It has been shown that the antagonists can be preserved in this form for up to 12 months with a decrease in the bacterial population in logarithmic order of no more than 2.

### Bacteria Long Term Storage

The antagonistic bacteria were maintained in the form of an agar containing media that was found to support long term (294 days) survival of the antagonistic bacteria.

Each of the antagonistic bacteria listed in Table 1 is also characterized by their capability to survive a long term cultivation period with oregano oil being the soil carbon source.

### Preparation of Biocontrol Formulation

Prior to application onto the eggs, the biocontrol formulation was prepared by mixing the dry particulate matter carrying the oregano oil and sesame oil, with the agar gel carrying 10⁷-10⁸ CFU/ml for each bacteria in the cocktail. Then, the mixture was diluted with water to obtain a concentration of each bacteria of not less than 10³ CFU/ml.

The concentration of the oil particulate matter in the final was defined by weight/volume liquid. In the various experiments provided herein the concentration of the particulate matter was in the range of 0.02%-2.0% and the exact concentration for each experiment is indicated in the relevant text therein.

After the oil particulate matter and bacterial cocktail are mixed with an amount of water to the predefined concentration (in the above defined range), the biocontrol cocktail was prepared and ready for use within the period of 12 hours from its preparation.

To increase activity, one or more of the following additives were also mixed into the formulation at a concentration of 2% w/w with respect to the weight of the particulate matter: Calcium carbonate, Magnesium sulfate, Potassium bicarbonate, Ammonium Phosphate dibasic.

The components were then diluted with water to a total volume of 50 L comprising 0.3% of the gel and 0.5% of the powder.

### Disinfection of Eggs

The following experiments were conducted on fertilized chicken hatchery eggs. Each study group included 15 eggs, of the age of up to 24 hours from their laying.

The biocontrol formulation is defined by the weight/volume of the particulate matter. The amount of each bacterium in the antagonistic cocktail is the same and is in the above recited range.

### Example I

A total of 75 eggs, divided into 5 treatment groups (15 per group) were pressure sprayed with the biocontrol formulation until runoff of excess formulation. Each group was treated with a different concentration of particulate matter, as detailed in Table 2:

TABLE 2
Disinfection with different concentrations in 500 ml pressure sprayer

| | | Amount of |
|---|---|---|
| Treatment No. | Concentration of particulate matter | particulate matter |
| 1 | Water | 0 |
| 2 | 0.2% | 0.5 gr |
| 3 | 0.4% | 1.0 gr |
| 4 | 0.8% | 2.0 gr |
| 5 | 1.0% | 2.5 gr |

The eggs were then allowed to air dry for 8 hours, at which point each egg was examined using one of the following techniques:
Collecting samples using a double ended media carrying swab, one side used for collecting bacteria (carrying media suitable for cultivating bacteria) and the other side for collecting fungi (carrying media suitable for cultivating fungi).
Collecting samples by double tip cotton swabs damped with sterilized water prior to collecting samples from the eggs and then collecting of samples from each egg by swapping the cotton tips over the egg's shell. Each cotton tip was then removed from the swab and placed in a sterile tube containing 9.5 ml sterile water and vortexed. This tube was used as source for various dilutions of the samples; each diluted sample was then placed, in duplicates, on petri dishes with media for cultivation of fungi or for cultivation of coliform.

After 5 days of incubation at 37° C., the number of colonies were counted and representative results are provided in Table 3.

TABLE 3
colony forming units after disinfecting with different biocontrol
concentrations

| | Coliform | Coliform | | |
|---|---|---|---|---|
| Concentration | (CFU/ml) | (%) | Total Fungi | Total Fungi (%) |
| Water only | 19 | 100 | 14 | 100 |
| 0.2% | 5 | 26.3 | 24 | 77.4 |
| 0.4% | 0 | 0 | 4 | 12.9 |
| 0.8% | 0 | 0 | 0.2 | 0.6 |
| 1.0% | 0 | 0 | 0.12 | 0.38 |

It is noted that this assay was repeated numerous times and each provided similar results. These results show that the disinfecting treatment was significantly effective in reducing pathogen contamination on the eggs, notwithstanding the fact that the bacteria were more sensitive to the disinfection treatment than the pathogenic fungi.

In a further experiment, the effect of the biocontrol formulation was tested on eggs artificially contaminated with E. Coli (as positive control). Specifically, eggs were sprayed, using an electrical sprayer (Bosh, PFS55) with a solution of E. coli until run off of the liquid and allowed to dry for about 4 hours, after which the eggs were treated with the biocontrol formulation (particle concentration 0.8%). The experiment was repeated 5 times, each time, 6 eggs per tested group.

After 8 hours of air drying each egg was tested using double tip cotton swabs damped with sterilized water and swapping the cotton tips over the egg's shell at least four times at different areas of the shell. Each cotton tip was then removed from the swab and placed in a sterile tube containing 5 ml sterile water and thoroughly vortexed. This tube was used as source for various dilutions of the samples; each diluted sample was then placed on petri dishes with media suitable for bacteria or fungi cultivation and incubated at 35° C. for 48 hours, for bacteria, or 28° C. for 5 days, for fungi. The colonies were then counted and those being suspicious were sent to identification. The procedure was repeated 5 times and the result of three are provided in Table 4:

TABLE 4
Colony forming units after disinfecting with different biocontrol
concentrations

| | Coliforms on | |
|---|---|---|
| Treatment | Swab (CFU/ml) | Fungi on Swab (CFU/ml) |
| Water only | 4.2 | 5.4 |
| Bacterial Positive Control | 1.6 × 10³ | 5.7 |
| Bacterial Positive Control | 4.1 | 3.3 × 10² |
| 0.8% (#1) | 0 | 0.06 |
| 0.8% (#2) | 0 | 0.05 |
| 1.0% (#3) | 0 | 1.2 |

The results show that while the artificially spraying of the eggs increases the pathogen count significantly (in logarithmic order) the disinfecting with the biocontrol formulation was effective both against bacterial contamination and fungal contamination.

In yet a further experiment, identical in conditions, however, with 170 eggs per group (total of 850 eggs) similar results were obtained, showing that from a concentration of 0.4% there was no difference in the effectiveness of the treatment.

Based on the above, several identical tests were conducted with formulations comprising 0.6% (1.0 gr), 0.8% (2.0 gr) and 1.0% (2.5 gr), water being used as control.

Tables 5A-5B shows the results obtained in two exemplary experiments (out of several providing similar results and same conclusions):

TABLE 5A
Colony forming units after treatment with different biocontrol
concentrations

| | Coliform | | | Total |
|---|---|---|---|---|
| Concentration | (CFU/ml) | Coliform (%) | Total Fungi | Fungi (%) |
| Water only | 3 | 100 | 2 | 100 |
| 0.4% | 0.4 | 13.3 | 4 | 50 |
| 0.8% | 0 | 0 | 0.1 | 5 |
| 1.0% | 0 | 0 | 0 | 0 |

TABLE 5B
colony forming units after treatment with different biocontrol
concentrations

| | Coliform | | | Total |
|---|---|---|---|---|
| Concentration | (CFU/ml) | Coliform (%) | Total Fungi | Fungi (%) |
| Water only | 15 | 100 | 8 | 100 |
| 0.4% | 2 | 13.3 | 4 | 50 |
| 0.8% | 0.10 | 0.6 | 0.1 | 1.25 |
| 1.0% | 0 | 0 | 0 | 0 |

### Example II—Duration of Effect

In a further experiment, the duration of effectiveness of the disinfecting treatment was assessed. Specifically, amount of pathogen contaminations were determined from day of treatment and several days after treatment, as indicated below.

Specifically, eggs (15) were either treated with a biocontrol formulation comprising 0.8% (2 gr) particulate matter, or water (as control). Samples were taken from the surface of the egg's shell using a cotton swab (as described above) and incubated for 5 days, as described above (Example I). The pathogen count is provided in Table 6:

TABLE 6
Colony forming units after treatment with different biocontrol
concentrations

| Day from | | Coliform | Coliform | Total | Total Fungi |
|---|---|---|---|---|---|
| treatment | Concentration | (CFU/ml) | (%) | Fungi | (%) |
| 0 | Water | 13 | 100 | 4 | 100 |
| | 0.8% | 0 | 0 | 0.1 | 2.5 |
| 3 | Water | 15 | 115 | 6 | 150 |
| | 0.8% | 0 | 0 | 0.1 | 1.6 |
| 6 | Water | 9 | 69 | 4 | 100 |
| | 0.8% | 0 | 0 | 0 | 0 |
| 10 | Water | 6 | 46 | 3 | 75 |
| | 0.8% | 0 | 0 | 0 | 0 |

The results show that the disinfecting treatment is effective even up to 10 days post spraying. Notably, while the count in the control group has also reduced, only following the biocontrol treatment, the count reduced to “0”.

### Example III—Effect of Additives on Fungi Growth

The effect of various additives on fungi growth was examined. The fungi examined included two isolates of Fusarium Spp. (isolate #1 and isolate #2), sclerotium, and trychoderma.

The effect of the following non-toxic additives without the biocontrol formulation was examined: sodium bicarbonate, diammonium phosphate, magnesiumsulphate hepta hydrate, potassium becarbonate. These additives were chosen based on the inventor's previous experience as fungi growth inhibitors.

Table 7 summarizes the amount of each additive added on colony size (in centimeters). The larger the colony's dimension (diameter) in the petri dish, the lower is the inhibitory effect of the additive. The initial diameter of the colony before treatment was 0.5 cm. Therefore, after the treatment, a diameter of 0.5 cm was indicative that the additive was effective in preventing growth of the colony.

The results also show that diammonium phosphate was the most effective in preventing fungi growth.

TABLE 7
effect of additives on fungi growth

| | | | | | | | Magnesium | | | | | | |
|---|---|---|---|---|---|---|---|---|---|---|---|---|---|
| | Sodium | | | Diammonium | | | sulphate | | | Potassium | | | |
| | bicarbonate | | | phasphate | | | hepta hydrate | | | bicarbonate | | | |
| Fungus | 2.5% | 5% | 10% | 2.5% | 5% | 10% | 2.5% | 5% | 10% | 2.5% | 5% | 10% | Control |
| Fusarium | 1.2 | 0.9 | 1.0 | 0.6 | 0.5 | 0.5 | 2.4 | 2.1 | 3.2 | 1.3 | 1.1 | 2.0 | 5.7 |
| Spp. (#1) | 1.2 | 1.0 | 1.1 | 1.0 | 0.5 | 0.5 | 2.5 | 2.0 | 3.1 | 0.9 | 1.1 | 1.8 | 5.3 |
| | n | n | 1.0 | n | n | 0.5 | n | n | 3.2 | n | n | 1.6 | n |
| | n | n | 1.1 | n | n | 0.5 | n | n | 3.1 | n | n | 1.5 | |
| Fusarium | 0.8 | 0.6 | 0.5 | 0.6 | 0.5 | 0.5 | 2.7 | 2.7 | 3.0 | 1.0 | 0.8 | 1.3 | 4.3 |
| Spp. (#2) | 0.9 | 0.6 | 0.5 | 0.6 | 0.5 | 0.5 | 2.8 | 2.3 | 3.1 | 1.1 | 0.8 | 1.2 | 4.4 |
| | n | n | 0.5 | n | n | 0.5 | n | n | 3.0 n | | n | 1.3 | |
| | n | n | 0.5 | n | n | 0.5 | n | n | 3.0 | n | n | 1.3 | |
| Sclerotium | 0.6 | 0.5 | 0.5 | 1.2 | 0.6 | 0.5 | 0.7 | 0.7 | 3.0 | 0.7 | 0.5 | 0.5 | 2.0 |
| | 0.6 | 0.5 | 0.5 | 0.9 | 0.5 | 0.5 | 0.7 | 0.6 | 2.7 | 0.7 | 0.5 | 0.5 | 2.3 |
| | n | n | 0.5 | n | n | 0.5 | n | n | 2.5 | n | n | 0.5 | |
| | n | n | 0.5 | n | n | 0.5 | n | n | 2.2 | n | n | 0.5 | |
| Trychoderma | 0.5 | 0.5 | 0.5 | 0.5 | 0.5 | 0.5 | 1.7 | 1.4 | 0.5 | 0.8 | 0.5 | 0.5 | 4.3 |
| | 0.5 | 0.5 | 0.5 | 0.5 | 0.5 | 0.5 | 1.7 | 1.0 | 0.5 | 0.8 | 0.5 | 0.5 | 4.5 |
| | n | n | 0.5 | n | n | 0.5 | n | n | 0.5 | n | n | 0.5 | |
| | n | n | 0.5 | n | n | 0.5 | n | n | 0.5 | n | n | 0.5 | |

n = no growth detected

In view of the results presented in Table 7, diammonium phosphate was selected for combination with the biocontrol formulation. Specifically, to a freshly prepared biocontrol formulation comprising 0.4% w/v of the first component (the particulate), an amount diammonium phosphate, (2% w/v DAP) was added. The effect of the mixture on fungi growth was examined, as compared to the control (water treatment only), the results of which is presented in Table 8.

TABLE 8
Effect of diammonium phosphate of fungi growth

| | | formulation | Control (water |
|---|---|---|---|
| Fungus | formulation 0.4% | 0.4% + DAP | only) |
| Fusarium spp. #1 | − | − | +++ |
| Fusarium spp. #2 | − | − | +++ |
| Sclerottium | + | − | +++ |
| Tricoderma spp. | ++ | − | +++ |

In the Table, “+++” indicates a significant fungi growth, i.e. no inhibitory effect of the particular treatment, “++” indicates medium growth, i.e. partial inhibitory effect on fungi growth; “+” indicates some but not significant growth, i.e. a high effect on growth, and “−” indicates no growth, namely, a significant anti-fungal effect.

The results show that the addition of a DAP, a commercially available fertilizer, to the biocontrol formulation increased the spectrum of activity and efficiency of the biocontrol formulation against fungi growth.

### Example IV—Effect of Biocontrol Formulation on Hatching

The effect of the biocontrol formulation on the percent of hatching was also examined.

Eggs from the same flock were collected on same day and incubated. Each egg was sprayed with the electrical sprayer (Bosh PFS55) with the biocontrol formulation (decreasing concentrations of powder % (the percentage indicated in the table below, and constant concentration of each bacteria being 10³ CFU/ml), until run off.

As positive control, a group of eggs were similarly sprayed with bromosept 50% (solution of 50% di-decyl-di-methyl-ammonium bromide), a commercial disinfectant for poultry and other livestock. The experiment included 5 repeats including 80 eggs in each repeat (total of 400 eggs examined). Each treated group was placed on a separate tray. On the day of hatching the chicks suitable for marketing (according to conventional standards) were counted and the results are summarized in Table 9:

TABLE 9
Effect of Biocontrol Formulation on hatching

| Disinfecting treatment | % Hatching | % Marketable chicks |
|---|---|---|
| Bromosept 50% | 87.6 | 82.8 |
| 0.2% | 87.4 | 83.0 |
| 0.4% | 87.8 | 83.1 |
| 0.8% | 87.5 | 82.8 |
| 1.0% | 87.6 | 82.5 |

The results show that the biocontrol formulation was effective at least as the commercial standard Bromosept 50%.

### Example V—Effect of Biocontrol Formulation on Edible (Unfertilized) Egg Freshness

The aim of this study is to determine the effect of the biocontrol formulation disclosed herein on the following factors important for the quality of edible eggs:
Control of shell egg contamination by Coliform bacteria;
Control of shell egg contamination by fungi and molds;
Prevention of contaminant from penetrating the shell;
Improvement of shelf life of the eggs determined by the level of freshness preservation according Haugh units measured along predetermined time points (intervals).

### Materials and Methods:

Fresh, unfertilized, eggs were collected from a farm 3 h before the treatment.

Treatment groups included:

Control Group—in which the eggs received no treatment

Treatment Group—in which the eggs were treated by ULV spray with a final formulation comprising 2% of the particulate matter and bacterial cocktail count at 5×10⁴ CFU/ml.

The Control and Treated groups were incubated at various temperatures, 7° C.-5° C.; 25° C.±2° C.; 30° C.±0.5° C. and 30° C.±0.5° C.

All groups were incubated at room (regular) humidity of or, if specifically indicated, at humidity above 90% (high humidity).

Total incubation time was 60 days and samples of 6 eggs were taken from day 1, at 10 day intervals for examination of the following (1) fungi population; (2) bacterial population (E. coli & Salmonella); and (3) freshness—Hauge unit & Grade, the latter being in accordance with the following egg freshness index:

| Haugh unit | Grade |
|---|---|
| 72 or higher | AA |
| 71-60 | A |
| 59-31 | B |
| 30 or lower | C |

### Results

### A. Contaminations on Egg Surface

The following Tables 10A to 10D provide the level of Colifoms (CFU/egg presenting combined/total population of E. coli and Salmonella spp), Fungi on the surface of the eggs and eggs freshness grade as a function of the incubation temperature. The values are the mean of total population—CFU/egg;

TABLE 10A
Egg quality after incubation at 5° C.-7° C.

| | Incubation Time | Coliform | | |
|---|---|---|---|---|
| Group | (Days) | (CFU/egg) | Fungi (CFU/egg) | Grade |
| Control | 1 | 11 | 6 | AA |
| Treatment | 1 | 0 | 1 | AA |
| Control | 10 | 13 | 8 | AA |
| Treatment | 10 | 0 | 2 | AA |
| Control | 21 | 10 | 14 | AA |
| Treatment | 21 | 0 | 1 | AA |
| Control | 30 | 12 | 14 | AA |
| Treatment | 30 | 0 | 1 | AA |
| Control | 40 | 9 | 13 | AA |
| Treatment | 40 | 0 | 0 | AA |
| Control | 62 | 10 | 16 | A |
| Treatment | 62 | 0 | 0 | AA |

TABLE 10B
Egg quality after incubation at 25° C.

| | Incubation Time | Coliform* | | |
|---|---|---|---|---|
| Group | (Days) | (CFU/egg) | Fungi (CFU/egg) | Grade |
| Control | 1 | 8 | 4 | AA |
| Treatment | 1 | 0 | 1 | AA |
| Control | 10 | 12 | 13 | A |
| Treatment | 10 | 0 | 3 | A |
| Control | 21 | 8 | 16 | A |
| Treatment | 21 | 0 | 2 | A |
| Control | 30 | 7 | 18 | B |
| Treatment | 30 | 0 | 4 | B |
| Control | 40 | 5 | 19 | B |
| Treatment | 40 | 0 | 2 | B |
| Control | 62 | 5 | 23 | B |
| Treatment | 62 | 0 | 1 | B |

TABLE 10C
Egg quality after incubation at 25° C., and more than 90% humidity
(relative humidity)

| | Incubation Time | Coliform* | | |
|---|---|---|---|---|
| Group | (Days) | (CFU/egg) | Fungi (CFU/egg) | Grade |
| Control | 1 | 12 | 5 | AA |
| Treatment | 1 | 0 | 0 | AA |
| Control | 10 | 57 | 500 | AA |
| Treatment | 10 | 0 | 70 | AA |
| Control | 21 | 68 | 900 | B |
| Treatment | 21 | 5 | 50 | A |
| Control | 30 | 366 | 1440 | C |
| Treatment | 30 | 1 | 500 | A |
| Control | 40 | 700 | 2000 | C |
| Treatment | 40 | 0 | 75 | A |
| Control | 62 | 840 | 2600 | C |
| Treatment | 62 | 2 | 110 | B |

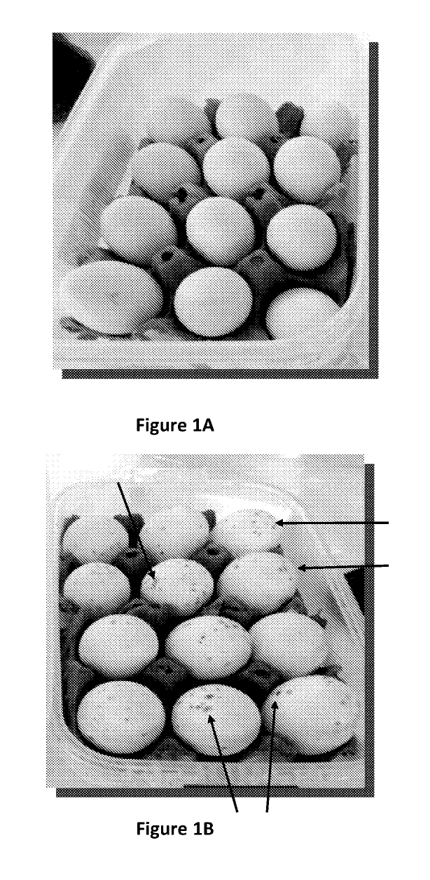

In addition, reference is made to FIGS. 1A and 1B showing photographic images of treated (FIG. 1A) and non-treated (FIG. 1B) eggs, after 14 days incubation at 25° C. and >90% humidity. Fungal growth on the shell of the eggs is clear from FIG. 1B.

TABLE 10D
Egg quality after incubation at 30° C.

| | Incubation | Coliform* | Fungi | | |
|---|---|---|---|---|---|
| Group | Time (Days) | (CFU/egg) | (CFU/egg) | | Grade |
| Control | 1 | 15 | 9 | | AA |
| Treatment | 1 | 0 | 0 | | AA |
| Control | 10 | 48 | 28 | | B |
| Treatment | 10 | 0 | 3 | | A |
| Control | 21 | 52 | 34 | | B |
| Treatment | 21 | 0 | 0 | | A |
| Control | 30 | 18 | 30 | | B |
| Treatment | 30 | 0 | 1 | Broken yolk | |
| Control | 40 | 6 | 31 | 53 | C |

| | | | | |
|---|---|---|---|---|
| Treatment | 40 | 0 | 5 | Broken yolk |
| Control | 62 | 5 | 29 | Dried Yolk |
| Treatment | 62 | 0 | 7 | Broken yolk |

Notably, a broken yolk or dried yolk indicates that storage for 30 or more days at 30° C. the eggs' freshness was not maintained.

B. Contaminations within the Egg

The following Tables 11A to 11E provide the level of Colifoms (CFU/egg presenting combined/total population of E. coli and Salmonella spp) and Fungi within the eggs (i.e. degree of contaimat penetration) as a function of the incubation temperature. The values are the mean of total population—CFU/egg;

TABLE 11A
Egg quality after incubation at 5° C.-7° C.

| | | | Fungi |
|---|---|---|---|
| Treatment | Incubation Time (Days) | Coliform (CFU/egg) | (CFU/egg) |
| Control | 1 | 0 | 0 |
| Treatment | 1 | 0 | 0 |
| Control | 10 | 0 | 0 |
| Treatment | 10 | 0 | 0 |
| Control | 21 | 0 | 0 |
| Treatment | 21 | 0 | 0 |
| Control | 30 | 0 | 0 |
| Treatment | 30 | 0 | 0 |
| Control | 40 | 0 | 0 |
| Treatment | 40 | 0 | 0 |
| Control | 62 | 0 | 0 |
| Treatment | 62 | 0 | 0 |

TABLE 11B
Egg quality after incubation at 25° C.

| | | | Fungi |
|---|---|---|---|
| Treatment | Incubation Time (Days) | Coliform (CFU/egg) | (CFU/egg) |
| Control | 1 | 0 | 0 |
| Treatment | 1 | 0 | 0 |
| Control | 10 | 0 | 0 |
| Treatment | 10 | 0 | 0 |
| Control | 21 | 0 | 0 |
| Treatment | 21 | 0 | 0 |
| Control | 30 | 0 | 0 |
| Treatment | 30 | 0 | 0 |
| Control | 40 | 0 | 0 |
| Treatment | 40 | 0 | 0 |
| Control | 62 | 0 | 3 |
| Treatment | 62 | 0 | 0 |

TABLE 11C
Egg quality after incubation at 25° C., and more than 90% humidity
(relative humidity)

| | | | Fungi |
|---|---|---|---|
| Treatment | Incubation Time (Days) | Coliform (CFU/egg) | (CFU/egg) |
| Control | 1 | 0 | 0 |
| Treatment | 1 | 0 | 0 |
| Control | 10 | 8 | 6 |
| Treatment | 10 | 0 | 0 |
| Control | 21 | 19 | 14 |
| Treatment | 21 | 0 | 1 |
| Control | 30 | 33 | 54 |
| Treatment | 30 | 2 | 6 |
| Control | 40 | 124 | 128 |
| Treatment | 40 | 5 | 11 |
| Control | 62 | 670 | 180 |
| Treatment | 62 | 7 | 16 |

TABLE 11D
Egg quality after incubation at 30° C.

| | | | Fungi |
|---|---|---|---|
| Treatment | Incubation Time (Days) | Coliform (CFU/egg) | (CFU/egg) |
| Control | 1 | 0 | 0 |
| Treatment | 1 | 0 | 0 |
| Control | 10 | 0 | 0 |
| Treatment | 10 | 0 | 0 |
| Control | 21 | 0 | 0 |
| Treatment | 21 | 0 | 0 |
| Control | 30 | 2 | 0 |
| Treatment | 30 | 0 | 0 |
| Control | 40 | 0 | 6 |
| Treatment | 40 | 0 | 0 |
| Control | 62 | 0 | 0 |
| Treatment | 62 | 0 | 0 |

TABLE 11D
Egg quality after incubation at 30° C., in high humidity (>90% RH)

| | | | Fungi |
|---|---|---|---|
| Treatment | Incubation Time (Days) | Coliform (CFU/egg) | (CFU/egg) |
| Control | 1 | 0 | 0 |
| Treatment | 1 | 0 | 0 |
| Control | 10 | 18 | 7 |
| Treatment | 10 | 0 | 4 |
| Control | 21 | 53 | 22 |
| Treatment | 21 | 2 | 2 |
| Control | 30 | 132 | 44 |
| Treatment | 30 | 6 | 12 |
| Control | 40 | 810 | 67 |
| Treatment | 40 | 11 | 18 |
| Control | 62 | 3070 | 87 |
| Treatment | 62 | 96 | 22 |

The results presented hereinabove lead to the following conclusions:
Eggs have the potential to deliver pathogens to consumers.
High humidity accelerates/supports Coliform and fungi growth on egg shell surface which can penetrate inside the eggs.
Egg storage outside refrigerator (temperatures above 7° C.) reduces the eggs freshness grade.
Under all the tested conditions treatment with the formulation disclosed herein was superior to the control (untreated) showing a better grade and less contamination by fungi and Coliform bacteria (complex of E. coli and Salmonella spp.) on the shell eggs surface and inside the eggs.

1.-46. (canceled)

47. A method for improving quality of shelled eggs, the method comprising:
applying onto the shelled egg a biocontrol formulation comprising
at least one first component comprising particulate matter holding at least one natural oil, and
at least one second component comprising a cocktail of antagonistic bacteria,
said at least one first component and said at least one second component being combined into said formulation prior to application onto the shelled egg surface.

48. The method of claim 47, wherein the natural oil is plant oil.

49. The method of claim 47, wherein the natural oil comprises at least one essential oil.

50. The method of claim 48, wherein the plant oil is carbon-rich nutrient oil.

51. The method of claim 47, wherein said particulate matter is characterized by at least one of: (i) it comprises silica (SiO2) particles; (ii) it has a size distribution in the range of 10-25 μm; (iii) it has a surface area in the range of 400-500 m2 N2/g; and (iv) it has an oil capacity in the range of 300-350 DBP/100 gram particulate.

52. The method of claim 47, wherein said formulation further comprises at least one surfactant.

53. The method of claim 47, wherein said second component is in the form of a gel.

54. The method of claim 47, wherein the antagonistic bacteria is characterized by any one or the following: (i) is a soil borne bacteria or is a bacterium isolated from a plant part; (ii) each of the antagonistic bacterium in the cocktail is capable of growing on sesame oil as a sole carbon source; (iii) the total count of each antagonistic bacterium in the cocktail in the range of between 500 CFU/ml to 5,000 CFU/ml.

55. The method of claim 47, wherein the cocktail of antagonistic bacteria comprise at least two bacteria selected from the group consisting of Pseudomonas species (Accession No. CBS133252), Pseudomonas alcaliphila (Accession No. CBS133254), Bacillus subtilis (Accession No. CBS133255), Pseudomonas cedrina (Accession No. CBS133256), Pseudomonas species (Accession No. CBS133257), Pseudomonas species (Accession No. CBS133258), Pseudomonas species (Accession No. CBS134568), Pseudomonas spanius (Accession No. CBS133259), Pseudomonas mediterranea (Accession No. CBS134566), Pseudomonas chlororahis (Accession No. CBS134567), and Pseudomonas species (Accession No. CBS134568).

56. The method of claim 47, wherein said formulation further comprises at least one inorganic salt.

57. The method of claim 56, wherein said inorganic salt is selected from the group consisting of ammonium nitrate, ammonium sulfate, ammonium trisulfate, calcium ammonium nitrate, calcium nitrate, diammonium phosphate, monocalcium phosphate, potassium chloride, potassium nitrate and potassium sulfate.

58. The method of claim 47, wherein improvement of quality of the shelled egg is exhibited by at least one of the following parameters:
(a) disinfecting biological contamination;
(b) improving freshness grade as determined in accordance with Haugh freshness index with a representative egg from a population of shelled eggs that received said formulation;
(c) improving hatchability of fertilized eggs; and
(d) elongating shelf life of non-fertilized eggs.

59. The method of claim 58, wherein said biological contamination is one or more pathogen selected from the group consisting of bacterial pathogen and fungi pathogen, and said biocontrol combination is used in a method for disinfecting the shelled egg.

60. The method of claim 47, comprising mixing said first component and second component of the biocontrol combination within a time window of at most 24 hours prior to application onto the egg.

61. The method of claim 60, wherein the formulation is prepared not more than 2 hours prior to application.

62. The method of claim 61, wherein said mixing comprises suspending in water the first component to form an emulsion and mixing the emulsion with the second component comprising the cocktail of antagonistic bacteria.

63. The method of claim 47, wherein the first component further comprises a surfactant, and the second component is in the form of a gel.

64. The method of claim 63, further comprising adding to the first component and second component at least one inorganic salt prior to application to provide a biocontrol formulation comprising said at least one inorganic salt.

65. The method of claim 47, wherein the biocontrol formulation is applied onto the egg's shell by any one or combination of: dipping the egg in the formulation; spraying the composition onto the egg's shell; rolling the egg over a substrate absorbed with said composition; brushing the egg's shell with the composition; and subjecting the eggs to mist comprising said biocontrol formulation.

66. The method of claim 47, further comprising applying the biocontrol formulation onto said egg at least once during a period of up to one day from laying; and after said application of said formulation, subjecting said egg to mist environment comprising said biocontrol formulation.
